(19) United States
(12) Patent Application Publication
(10) Pub. No.: US 2025/0164325 A1
(43) Pub. Date: May 22, 2025

(54) SENSOR MODULE AND FORCE SENSOR DEVICE

(71) Applicant: MINEBEA MITSUMI Inc., Nagano (JP)

(72) Inventor: Shinya YAMAGUCHI, Tokyo (JP)

(21) Appl. No.: 18/730,487

(22) PCT Filed: Jan. 18, 2023
(86) PCT No.: PCT/JP2023/001359

§ 371 Date: Jul. 19, 2024

(30) Foreign Application Priority Data
Jan. 25, 2022 (JP) 2022-009568

(51) Int. Cl. G01L 1/18

(52) U.S. Cl. CPC G01L 1/18

(57) ABSTRACT

A sensor module includes a substrate, a sensor chip mounted on one surface of the substrate to detect a predetermined axial displacement, a bonding wire that electrically couples a first electrode formed on the one surface of the substrate to a second electrode of the sensor chip, and a protective frame provided on the periphery of the one surface of the substrate. The protective frame is apart from the bonding wire.

### TECHNICAL FIELD

The present disclosure relates to a sensor module and a force sensor device.

### BACKGROUND

Force sensor devices for detecting displacement in one or more predetermined axial directions have been known. In an example, a force sensor device includes a structure including a sensor chip; an external-force receiving plate that is disposed around the sensor chip and to which an external force is applied; a base that supports the sensor chip; an external force-buffering mechanism that secures the external-force receiving plate to the base; and a coupling rod that is an external force-transmitting mechanism. The external-force receiving plate and an effect portion are coupled to each other by the coupling rod (see, e.g., Patent Document 1).

### RELATED-ART DOCUMENT

### Patent Document

Patent Document 1: Japanese Unexamined Patent Application Publication No. 2003-254843

### Summary

### Problem to be Solved by the Invention

In the force sensor device described in Patent Document 1, a sensor is directly mounted on a housing having a structure that includes the base, a buffer support, and the external-force receiving plate. When the sensor is mounted on the housing that is very large as compared to the sensor, there is a problem that a semiconductor mounting device interferes because a greater distance from a top surface of the housing to a sensor surface is obtained in a wire bonding process for extracting a signal from the sensor. As a result, a typical semiconductor mounting device cannot be used, which may result in reductions in mass production.

The present invention is created in light of the above situation, and an object of the present invention is to provide a sensor module capable of improving mass production of a force sensor device.

### Means for Solving the Problem

A sensor module (300) includes a substrate (310), a sensor chip (100) mounted on one surface of the substrate (310) and configured to detect a predetermined axial displacement, a bonding wire (90) that electrically couples a first electrode (313) formed on the one surface of the substrate (310) to a second electrode (110) of the sensor chip (100), and a protective frame (320) provided on the periphery of the one surface of the substrate (310), the protective frame being apart from the bonding wire (90).

Note that the numerals within the above brackets are expressed for ease of understanding, and are intended only to illustrate an example. The numerals are not limited to the manners in the figures.

### Effects of the Invention

In a disclosed technique, a sensor module capable of improving mass production of a force sensor device can be provided.

### BRIEF DESCRIPTION OF THE DRAWINGS

FIG. 1 is a perspective view of a force sensor device according to one embodiment.

FIG. 2 is a perspective view of a state in which a cover plate of the force sensor device according to one embodiment is removed.

FIG. 3 is a cross-sectional perspective view viewed in the I-I section of FIG. 2.

FIG. 4 is a perspective view of a state in which the cover plate is removed from the strain inducing body.

FIG. 5 is a perspective view of a sensor module according to one embodiment.

FIG. 6 is a plan view of the sensor module according to one embodiment.

FIG. 7 is a bottom view of the sensor module according to one embodiment.

FIG. 8 is a perspective view of a substrate.

FIG. 9 is a perspective view of a sensor chip when viewed from an upper side in a Z-axis direction.

FIG. 10 is a plan view of the sensor chip when viewed from the upper side in the Z-axis direction.

FIG. 11 is a perspective view of the sensor chip when viewed from a bottom side in the z-axis direction.

FIG. 12 is a bottom view of the sensor chip when viewed from the bottom side in the Z-axis direction.

FIG. 13 is a diagram for describing signs for forces and moments applied to axes.

FIG. 14 is a diagram showing an arrangement example of piezoresistive elements of the sensor chip.

FIG. 15 is a partial enlarged view of one sensing block of the sensor chip shown in FIG. 14.

FIG. 16 is a diagram (No. 1) showing an example of a detecting circuit using piezoresistive elements.

FIG. 17 is a diagram (No. 2) showing an example of the detecting circuit using piezoresistive elements.

FIG. 18 is a diagram for describing an input Fx.

FIG. 19 is a diagram for describing an input Fy.

FIG. 20 is a plan view of a state of a sensor module from which the upper substrate is removed in a modification of the embodiment.

FIG. 21 is a plan view of the upper substrate of the sensor module in the modification of the embodiment.

FIG. 22 is a plan view of the sensor module in the modification of the embodiment.

FIG. 23 is a view viewed in the II-II section of FIG. 22.

### MODE FOR CARRYING OUT THE INVENTION

Hereinafter, embodiments for carrying out the present invention will be described with reference to the drawings. In each drawing, the same components are denoted by the same numerals, and duplicate description may be omitted.

### Force Sensor Device 1

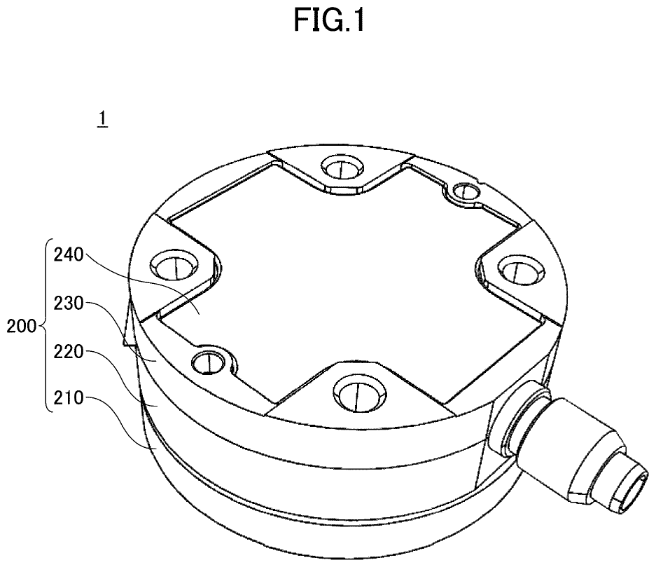

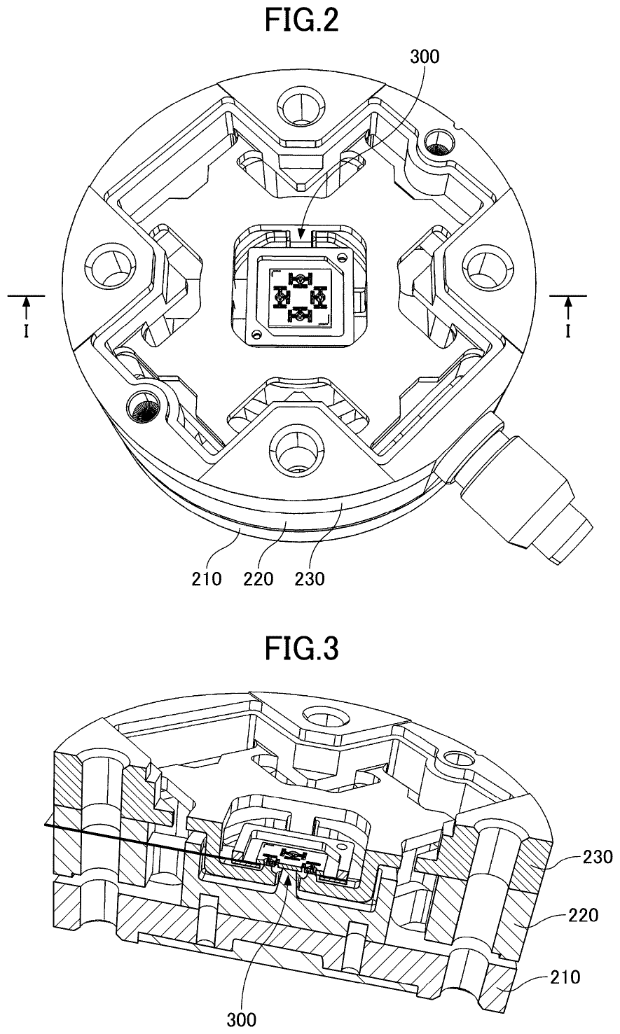

FIG. 1 is a perspective view of a force sensor device according to one embodiment. FIG. 2 is a perspective view of a state of the force sensor device from which a cover plate is removed according to one embodiment. FIG. 3 is a cross-sectional perspective view viewed in the I-I section of FIG. 2. Referring to FIGS. 1 to 3, the force sensor device 1 includes a sensor module 300 and a strain inducing body 200. The force sensor device 1 is a multi-axis force sensor device that is mounted on, for example, an arm, a finger, or the like of a robot used in a machine tool or the like.

The strain inducing body 200 includes a force receiving plate 210, a strain inducing portion 220, an input transmitter 230, and a cover plate 240. The strain inducing portion 220 is laminated on the force receiving plate 210, the input transmitter 230 is laminated on the strain inducing portion 220, and the cover plate 240 is laminated on the input transmitter 230. As a result, a generally cylindrical strain inducing body 200 is formed as a whole. A function of the strain inducing body 200 is mainly implemented by the strain inducing portion 220 and the input transmitter 230. In this arrangement, the force receiving plate 210 and the cover plate 240 may be provided as necessary.

In the present embodiment, for convenience, in the force sensor device 1, a cover plate 240-side is referred to as an upper side or one side, and a force receiving plate 210-side is referred to as a bottom side or the other side. A surface of each component on the cover plate 240-side is referred to as one surface or an upper surface, and a surface on a force receiving plate 210-side is referred to as the other surface or a lower surface. However, the force sensor device 1 can be used in a state of being upside down, or can be disposed at any angle. A plane view means that an object is viewed in a direction (Z-axis direction) normal to the upper surface of the cover plate 240, and a planar shape refers to a shape of the object when viewed in direction (Z-axis direction) normal to the upper surface of the cover plate 240.

As shown in FIGS. 2 and 3, a sensor module 300 is attached to the input transmitter 230 of the strain inducing body 200. The sensor module 300 holds a sensor chip 100 and is detachable from the strain inducing body 200.

The sensor chip 100 has a function of detecting up to six axes relating to displacements in predetermined axial directions. The strain inducing body 200 has a function of transmitting an applied force and/or moment to the sensor chip 100. In the following embodiments, in an example, a case where the sensor chip 100 detects six axes will be described, but the case is not limiting. For example, a case or the like where the sensor chip 100 detects three axes can be used.

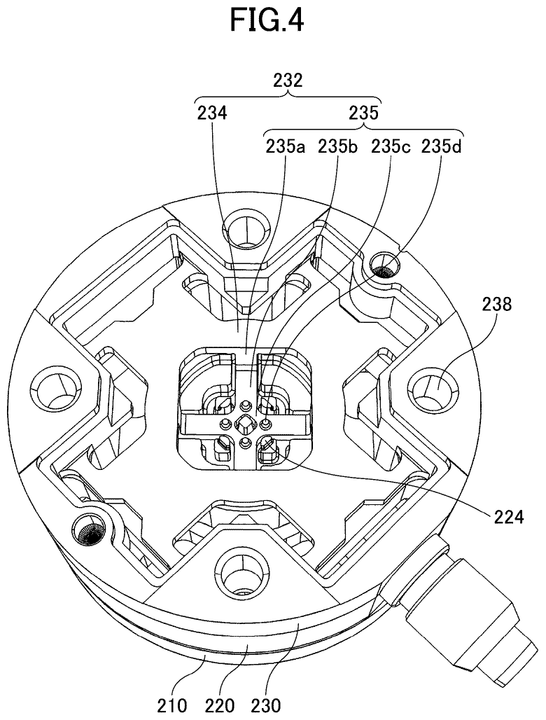

FIG. 4 is a perspective view of a state of the strain inducing body 200 from which the cover plate 240 is removed. As shown in FIG. 4, the input transmitter 230 includes an accommodating portion 235 that protrudes from the lower surface of the input transmitter 230 toward the strain inducing portion 220. In addition, the sensor module 300 is fixed to a cover plate 240-side of the accommodating portion 235. When the sensor module 300 is attached to the input transmitter 230, the accommodating portion 235 is used to enable the sensor module 300 to be attached with high positional accuracy.

Specifically, a central portion 232 includes a first coupling portion 234 having a substantially ring shape in plan view, and includes the accommodating portion 235 having a substantially cross shape that extends from the lower surface of the first coupling portion 234 toward the strain inducing portion 220.

The accommodating portion 235 is provided inside the first coupling portion 234, and can accommodate the sensor chip 100.

The accommodating portion 235 includes four vertical supports 235a that are each connected at one end to the first coupling portion 234 and that extend vertically from the lower surface of the first coupling portion 234 toward the strain inducing portion 220; four horizontal supports 235b that extend horizontally from respective lower ends of the vertical supports 235a; and a second coupling portion 235c that couples ends of the horizontal supports 235b.

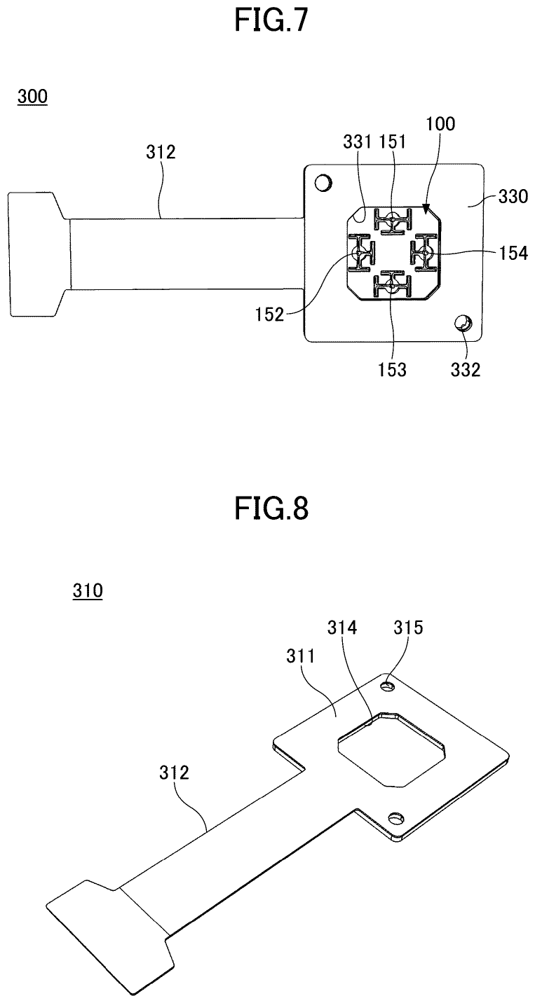

Four second connecting portions 235d that protrude toward the cover plate 240 are arranged in the accommodating portion 235. The respective second connecting portions 235d are connected to lower surfaces of force points 151 to 154 (see FIG. 7 and the like below) of the sensor chip 100.

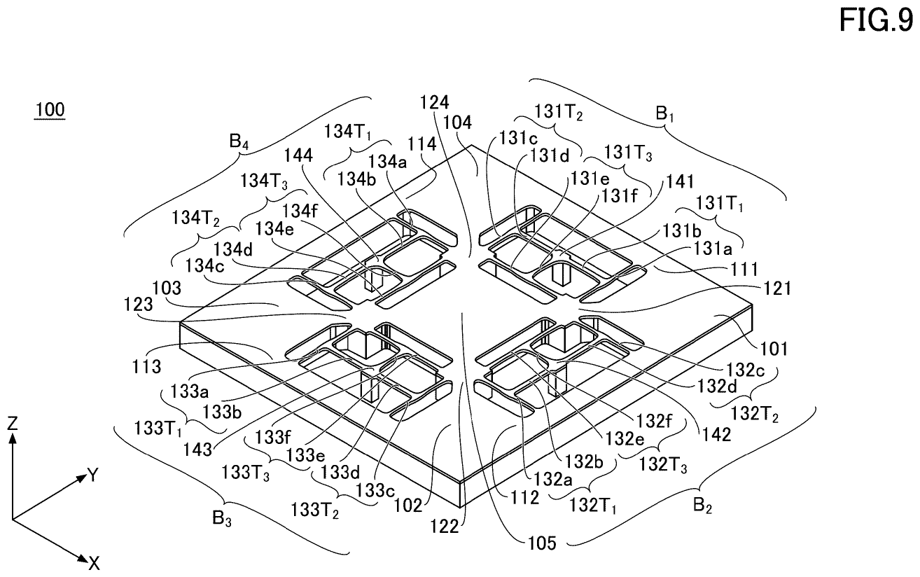

The accommodating portion 235 enters the strain inducing portion 220. Five first connecting portions 224, each of which has a columnar shape and protrudes toward the input transmitter 230, are provided in the strain inducing portion 220. The first connecting portions 224 are each connected to at least a portion of the lower surface of a corresponding support (see FIGS. 9 to 12 and the like below) among the supports 101 to 105 of the sensor chip 100.

When a force or a moment is applied to the force receiving plate 210 in the strain inducing body 200, the force or the moment is transmitted to the central portion of the strain inducing portion 220 connected to the force receiving plate 210, and thus each of four beam structures (not shown) deforms in response to receiving an input, for example. At this time, an outer frame of the strain inducing portion 220 and the input transmitter 230 does not deform.

That is, in the strain inducing body 200, the force receiving plate 210, and the central portion and the beam structures of the strain inducing portion 220 are movable portions that deform in response to receiving a predetermined axial force or a moment about a predetermined axis, and the outer frame of the strain inducing portion 220 is a non-movable portion that does not deform in response to receiving the force or moment. In addition, the input transmitter 230 joined to the outer frame of the strain inducing portion 220, which is a non-movable portion, is a non-movable portion that does not deform in response to receiving the force or moment.

The cover plate 240 joined to the input transmitter 230 is also a non-movable portion that does not deform in response to receiving the force or moment.

When the strain inducing body 200 is used in the force sensor device 1, the supports 101 to 105 of the sensor chip 100 are respectively connected to the first connecting portions 224 provided at the central portion of the strain inducing portion 220 that is a movable portion. The force points 151 to 154 of the sensor chip 100 are respectively connected to the second connecting portions 235d provided in the accommodating portion 235 that is a non-movable portion. In this arrangement, the sensor chip 100 operates such that detection beams deform through the respective supports 101 to 105 without the movement of the force points 151 to 154.

However, the force points 151 to 154 of the sensor chip 100 may be connected to the first connecting portions 224 provided at the central portion of the strain inducing portion 220, which is a movable portion, and the supports 101 to 105 of the sensor chip 100 may be respectively connected to the second connecting portions 235d provided in the accommodating portion 235, which is a non-movable portion.

That is, the sensor chip 100 that can be accommodated in the accommodating portion 235 includes the supports 101 to 105 and the force points 151 to 154, and a positional relationship between supports, as well as a positional relationship between force points, change in response to receiving a force or moment. In the strain inducing body 200, the central portion that is a movable portion includes the first connecting portions 224 each of which extends toward the input transmitter 230 and is connected to both a corresponding support among the supports 101 to 105 and one end of a corresponding force point among the force points 151 to 154. The accommodating portion 235 includes the second connecting portions 235d each of which is connected to both the corresponding support among the supports 101 to 105 and the other end of the corresponding force point among the force points 151 to 154.

The sensor module 300 will be described in detail below.

### Sensor Module 300

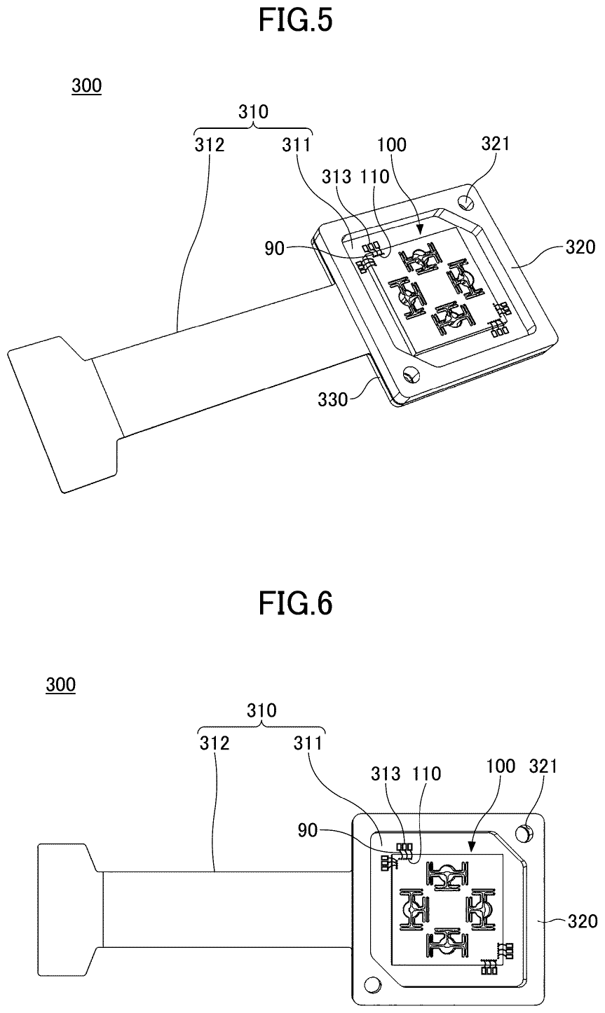

FIG. 5 is a perspective view of the sensor module 300 according to one embodiment. FIG. 6 is a plan view of the sensor module 300 according to one embodiment. FIG. 7 is a bottom view of the sensor module 300 according to one embodiment. FIG. 8 is a perspective view of a substrate 310.

The sensor module 300 shown in FIGS. 5 to 7 includes the substrate 310 and the sensor chip 100 that is mounted on the upper surface (one surface) of the substrate 310 and that detects a predetermined axial displacement. First electrodes (bonding pads) 313 are each formed on the upper surface (one surface) of the substrate 310, and the first electrodes 313 and second electrodes 110 of the sensor chip 100 are electrically connected by respective bonding wires 90. A protective frame 320 that is provided at the periphery of the upper surface (one surface) of the substrate 310 is separated from the bonding wires 90.

Further, a reinforcing plate 330 may be provided on the lower surface (the other surface) of the substrate 310.

The sensor chip 100 is mounted such that a lower surface is oriented toward the upper surface of the substrate 310, and the lower surface is situated opposite an electrode-formation surface on which the second electrodes 110 are formed.

As shown in FIG. 8, the substrate 310 has an opening (first opening) 314 for exposing a portion of the back surface of the sensor chip 100. Specifically, the force points 151 to 154 described below of the sensor chip 100 are exposed through the opening 314.

The shape of the substrate 310 is not particularly limited, but in the shape, for example, a mounting portion 311 on which the sensor chip 100 is mounted and an arm portion 312 from which the mounting portion 311 extends. The opening 314 may be provided in the mounting portion 311. By including the arm portion 312, the arm portion 312 can be held when the sensor module 300 is attached to the input transmitter 230, and the sensor module 300 can be easily attached to the input transmitter 230.

The substrate 310 may have locating holes 315. When the sensor module 300 is attached to the input transmitter 230, the locating holes 315 are holes that engage with protruding portions of the input transmitter 230 and that allow for positioning. In the example of FIG. 8, two locating holes 315 each of which has a circular shape in plan view are provided such that the central portion of the mounting portion 311 is interposed between the locating holes.

The thickness of the substrate 310 is not particularly limited and can be appropriately selected according to the purpose. For example, such a thickness is approximately 30 μm to 500 μm.

The substrate 310 may be a flexible substrate (FPC) or a rigid substrate. Examples of the material that constitutes the flexible substrate include a polyimide (PI) resin, an epoxy resin, a polyetheretherketone (PEEK) resin, a polyethylene naphthalate (PEN) resin, a polyethylene terephthalate (PET) resin, a polyphenylene sulfide (PPS) resin, a polyolefin resin, and the like. Examples of the material that constitutes the rigid substrate include a glass epoxy resin, a ceramic, and the like.

The protective frame 320 is a member for protecting the sensor chip 100 and the bonding wire 90 from contact with any other member(s). In the example of FIG. 5, the protective frame 320 is provided on the periphery of the upper surface of the mounting portion 311. That is, the arm portion 312 extends from the protective frame 320. The upper surface of the protective frame 320 is preferably located higher than a top position of each bonding wire 90. As a result, it is possible to prevent the bonding wires 90 from contacting any other member(s) that are located on an electrode-formation surface side of the sensor chip 100.

The protective frame 320 may have one or more locating holes 321. When the sensor module 300 is attached to the input transmitter 230, one or more locating holes 321 are holes each of which engages with a protruding portion of the input transmitter 230 and allows for positioning. In the examples shown in FIGS. 5 and 6, two locating holes 321 having a circular shape in plan view are provided such that the central portion of the protective frame 320 is interposed between the locating holes.

The thickness of the protective frame 320 is not particularly limited and can be appropriately selected according to the purpose. Preferably, the thickness of the protective frame 320 is greater than each of the thickness of the sensor chip 100 and a height of the top of the bonding wire 90 from the upper surface of the substrate 310. The thickness of the protective frame 320 can be, for example, approximately 700 μm to 1000 μm.

The material of the protective frame 320 is not particularly limited as long as the material is an insulating material. For example, the material of the protective frame 320 includes a polyphenylene sulfide (PPS) resin, a glass epoxy resin, or the like. The reinforcing plate 330 is a member for reinforcing the substrate 310. In particular, when the substrate 310 is a flexible substrate, the substrate 310 is reinforced with the reinforcing plate 330. With this arrangement, implementation of the sensor chip can be improved when performing die bonding or wire bonding, and when the sensor module 300 is attached to the input transmitter 230, the attachment is easily performed.

As shown in FIG. 7, the reinforcing plate 330 has an opening (second opening) 331 through which a portion of the lower surface of the sensor chip 100 is exposed. Specifically, the force points 151 to 154 of the sensor chip 100 are exposed through the opening 331.

The reinforcing plate 330 may have one or more locating holes 332. When the sensor module 300 is attached to the input transmitter 230, the locating hole 332 are holes each of which engages with protruding portions of the input transmitter 230 and that allows for positioning. In the example shown in FIG. 7, two locating holes 332 each of which has a circular shape in plan view are provided such that the central portion of the reinforcing plate 330 is interposed between the holes. The locating hole 315 of the substrate 310, the locating hole 321 of the protective frame 320, and the locating hole 332 of the reinforcing plate 330 overlap in plan view, and these locating holes constitute one communicating locating hole.

The thickness of the reinforcing plate 330 is not particularly limited and can be appropriately selected according to the purpose. Preferably, the thickness of the reinforcing plate 330 is less than the thickness of the sensor chip 100. The thickness of the reinforcing plate 330 can be, for example, approximately 100 μm to 500 μm.

The material of the reinforcing plate 330 is not particularly limited as long as the material is an insulating material. For example, a polyphenylene sulfide (PPS) resin, a glass epoxy resin, or the like is adopted.

Hereinafter, a method for assembling the sensor module 300 will be described.

First, an adhesive is applied to four corners of the periphery of the opening 314 on the upper surface of the substrate 310. For example, resin such as an epoxy resin or silicone resin can be used as the adhesive. Then, the sensor chip 100 is arranged on the substrate 310 so as to cover the opening 314, and die bonding is performed. The second electrodes 110 of the sensor chip 100 and the first electrodes 313 of the substrate 310 are respectively connected by bonding wires 90 (wire bonding). Then, the protective frame 320 is fixed to the peripheral of the upper surface of the mounting portion 311 with an adhesive. As the adhesive, the same adhesive as described above can be used. Further, the reinforcing plate 330 may be fixed to the lower surface of the mounting portion 311 with an adhesive. Hereinafter, the sensor chip 100 will be described in detail. In the following description, the “perpendicular” is intended to cover a case where an angle between two straight lines, sides, or the like is in the range of 90°±10°. However, the above case is not limiting when a special description is provided. Also, the words “center” and “middle” are intended to cover an approximate center and middle of an object, and are not intended to mean only an exact center and middle. That is, variations in manufacturing error shall be tolerable. The same applies to point symmetry or the like.

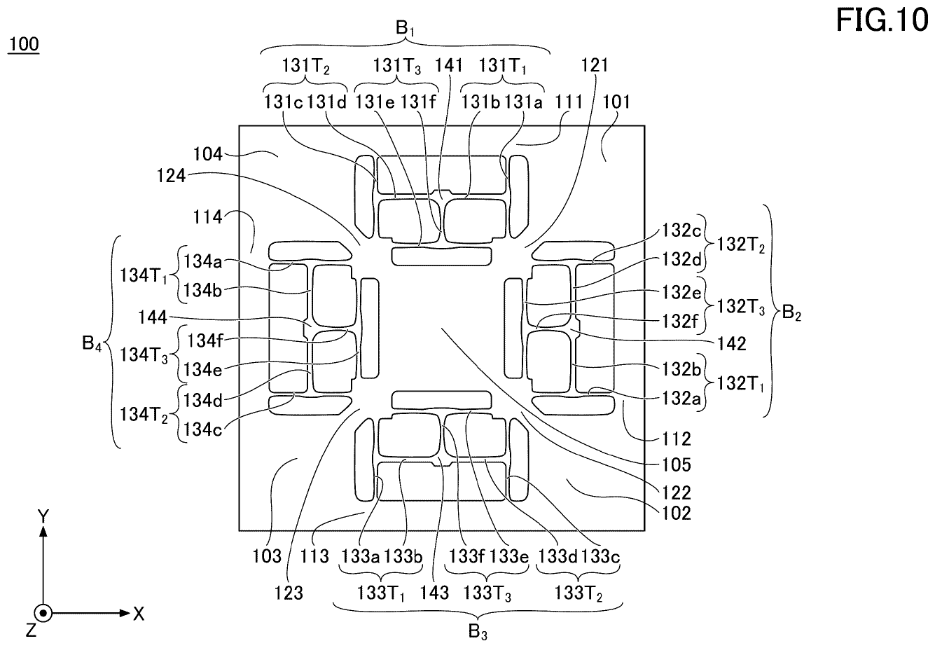

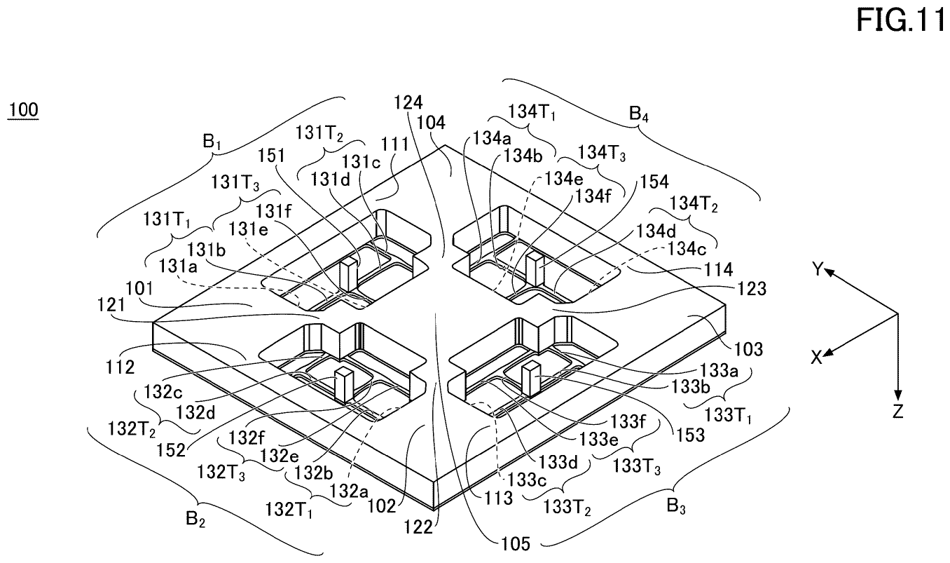

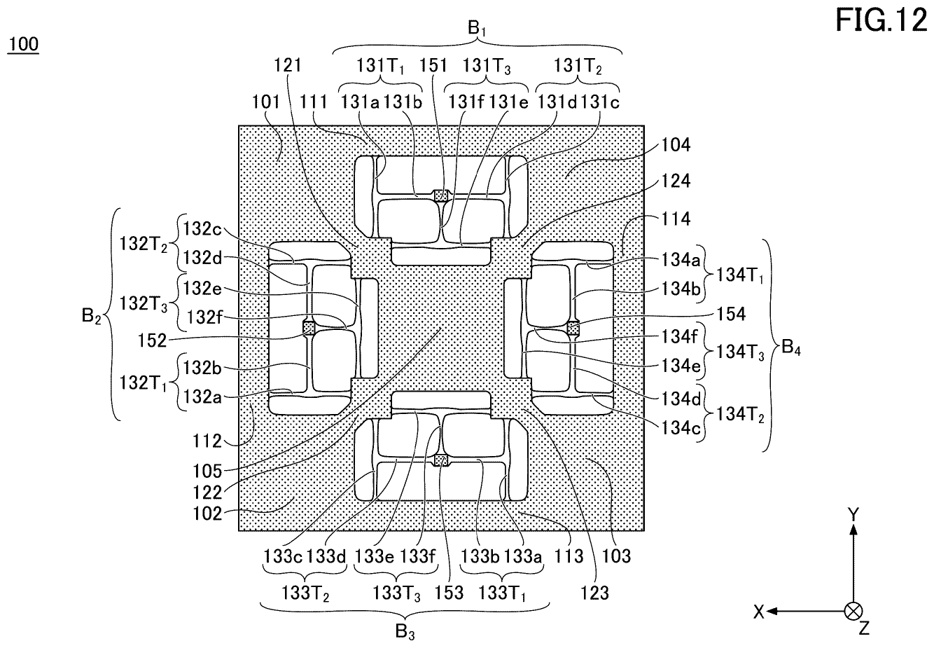

FIG. 9 is a perspective view of the sensor chip 100 when viewed from the upper side in the Z-axis direction. FIG. 10 is a plan view of the sensor chip 100 when viewed from the upper side in the Z-axis direction. FIG. 11 is a perspective view of the sensor chip 100 when viewed from the bottom side in the Z-axis direction. FIG. 12 is a bottom view of the sensor chip 100 when viewed from the bottom side in the Z-axis direction. In FIG. 12, for the sake of convenience, surfaces at the same height are shown in the same crepe pattern. Here, the direction parallel to one side of the upper surface of the sensor chip 100 refers to the X-axis direction, a direction perpendicular to one side of the upper surface of the sensor chip 100 refers to the Y-axis direction, and a thickness direction (a direction normal to the upper surface of the sensor chip 100) of the sensor chip 100 refers to the Z-axis direction. The X-axis direction, the Y-axis direction and the Z-axis direction are mutually perpendicular.

The sensor chip 100 shown in FIGS. 9 to 12 is a microelectromechanical systems (MEMS) sensor chip that is one chip and can detect up to six axes. The sensor chip 100 is formed of a semiconductor substrate such as a silicon on insulator (SOI) substrate. The planar shape of the sensor chip 100 can be, for example, an approximate 7000 μm per side rectangle (square or rectangle).

The sensor chip 100 includes five columnar supports 101 to 105. The planar shape of each of the supports 101 to 105 can be, for example, an approximate 2000 μm per side square. The supports 101 to 104 are respectively disposed at four corners of the rectangular sensor chip 100. The support 105 is disposed on a central portion of the rectangular sensor chip 100. Each of the supports 101 to 104 is a representative example of a first support according to the present invention, and the support 105 is a representative example of a second support according to the present invention.

A frame 112 (for coupling supports that are next to each other) of which both ends are fixed by the support 101 and the support 102 is provided between the support 101 and the support 102. A frame 113 (for coupling supports that are next to each other) of which both ends are fixed by the support 102 and the support 103 is provided between the support 102 and the support 103.

A frame 114 (for coupling supports that are next to each other) of which both ends are fixed by the support 103 and the support 104 is provided between the support 103 and the support 104. A frame 111 (for coupling supports that are next to each other) of which both ends are fixed by the support 104 and the support 101 is provided between the support 104 and the support 101.

In other words, four frames 111, 112, 113, and 114 are formed as a frame, and the supports 101, 102, 103, and 104 are each disposed at a corner at which given frames are coupled to each other.

An internal corner of the support 101 and a corner of the support 105 facing the internal corner of the support 101 are coupled by a coupling portion 121. An internal corner of the support 102 and a corner of the support 105 facing the internal corner of the support 102 are coupled by a coupling portion 122.

An internal corner of the support 103 and a corner of the support 105 facing the internal corner of the support 103 are coupled by a coupling portion 123. An internal corner of the support 104 and a corner of the support 105 facing the internal corner of the support 104 are coupled by a coupling portion 124. In this arrangement, the sensor chip 100 includes the coupling portions 121 to 124 each of which couples the support 105 and a corresponding support among the supports 101 to 104. The coupling portions 121 to 124 are each disposed diagonally relative to the X-axis direction (Y-axis direction). The coupling portions 121 to 124 are respectively disposed so as not to be parallel to the frames 111, 112, 113, and 114.

The supports 101 to 105, the frames 111 to 114, and the coupling portions 121 to 124 can be each formed of, for example, an active layer, a BOX layer, and a support layer of the SOI substrate. The thickness of each of those layers can be, for example, approximately in the range of 400 μm to 600 μm.

The sensor chip 100 has four sensing blocks B₁ to B₄. Each sensing block includes three T-patterned beam structures in each of which piezoresistive elements being strain-detecting elements are disposed. The T-patterned beam structure refers to a structure that includes a first detection beam and a second detection beam that extends from a middle portion of the first detection beam in a direction perpendicular to the first detection beam.

The detection beam refers to a beam in which a piezoresistive element can be arranged, but the piezoresistive element may not necessarily be arranged. That is, the detection beam can detect forces and moments by arranging the piezoresistive element, but the sensor chip 100 may have a detection beam in which the piezoresistive element is not arranged and is not used for detecting forces and moments.

Specifically, the sensing block B₁ includes T-patterned beam structures 131T₁, 131T₂, and 131T₃. The sensing block B₂ includes T-patterned beam structures 132T₁, 132T₂, and 132T₃. The sensing block B₃ includes T-patterned beam structures 133T₁, 133T₂, and 133T₃. The sensing block B₄ includes T-patterned beam structures 134T₁, 134T₂, and 134T₃. The beam structure will be described below in more details.

In the sensing block B₁, in plan view, a first detection beam 131a is provided parallel to a side of the support 101 toward the support 104 so as to be at a predetermined distance from the side of the support 104, and the first detection beam 131a extends between the frame 111 toward the support 101 and the coupling portion 121 toward the support 105. A second detection beam 131b is provided such that one end of the second detection beam is coupled at a middle portion of the first detection beam 131a in a longitudinal direction. The second detection beam 131b extends toward the support 104 in a direction perpendicular to the longitudinal direction of the first detection beam 131a. The first detection beam 131a and the second detection beam 131b constitute the T-patterned beam structure 131T₁.

In plan view, a first detection beam 131c is provided parallel to a side of the support 104 toward the support 101 so as to be at a predetermined distance from the side of the support 104, and the first detection beam 131c extends between the frame 111 toward the support 104 and the coupling portion 124 toward the support 105. A second detection beam 131d is provided such that one end of the second detection beam is coupled at a middle portion of the first detection beam 131c in a longitudinal direction, and the second detection beam 131d extends toward the support 101 in a direction perpendicular to the longitudinal direction of the first detection beam 131c. The first detection beam 131c and the second detection beam 131d constitute the T-patterned beam structure 131T₂.

In plan view, a first detection beam 131e is provided parallel to a side of the support 105 toward the frame 111 so as to be at a predetermined distance from the side of the support 105, and the first detection beam 131e extends between the coupling portion 121 toward the support 105 and the coupling portion 124 toward the support 105. A second detection beam 131f is provided such that one end of the second detection beam is coupled at a middle portion of the first detection beam 131e in a longitudinal direction, and the second detection beam 131f extends toward the frame 111 in a direction perpendicular to the longitudinal direction of the first detection beam 131e. The first detection beam 131e and the second detection beam 131f constitute the T-patterned beam structure 131T₃.

The other end of the second detection beam 131b, the other end of the second detection beam 131d, and the other end of the second detection beam 131f are connected to one another to thereby form a connecting portion 141. A force point 151 is provided at the lower surface of the connecting portion 141. The force point 151 has, for example, a rectangular prismatic shape. The T-patterned beam structures 131T₁, 131T₂, and 131T₃, the connecting portion 141, and the force point 151 constitute the sensing block B₁.

In the sensing block B₁, the first detection beam 131a, the first detection beam 131c, and the second detection beam 131f are parallel to one another. Also, the second detection beams 131b and 131d are parallel to the first detection beam 131e. The thickness of each detection beam in the sensing block B₁ can be, for example, approximately in the range of 30 μm to 50 μm.

In the sensing block B₂, in plan view, a first detection beam 132a is provided parallel to a side of the support 102 toward the support 101 so as to be at a predetermined distance from the side of the support 102, and the first detection beam 132a extends between the frame 112 toward the support 102 and the coupling portion 122 toward the support 105. A second detection beam 132b is provided such that one end of the second detection beam is coupled at a middle portion of the first detection beam 132a in a longitudinal direction, and the second detection beam 132b extends toward the support 101 in a direction perpendicular to the longitudinal direction of the first detection beam 132a. The first detection beam 132a and the second detection beam 132b constitute the T-patterned beam structure 132T₁.

In plan view, a first detection beam 132c is provided parallel to a side of the support 101 toward the support 102 so as to be at a predetermined distance from the side of the support 101, and the first detection beam 132c extends between the frame 112 toward the support 101 and the coupling portion 121 toward the support 105. A second detection beam 132d is provided such that one end of the second detection beam is coupled at a middle portion of the first detection beam 132c in a longitudinal direction, and the second detection beam 132d extends toward the support 102 in a direction perpendicular to the longitudinal direction of the first detection beam 132c. The first detection beam 132c and the second detection beam 132d constitute the T-patterned beam structure 132T₂.

In plan view, a first detection beam 132e is provided parallel to a side of the support 105 toward the frame 112 so as to be at a predetermined distance from the side of the support 105, and the first detection beam 132e extends between the coupling portion 122 toward the support 105 and the coupling portion 121 toward the support 105. A second detection beam 132f is provided such that one end of the second detection beam is coupled at a middle portion of the first detection beam 132e in a longitudinal direction, and the second detection beam 132f extends toward the frame 112 so as to be perpendicular to the longitudinal direction of the first detection beam 132e. The first detection beam 132e and the second detection beam 132f constitute the T-patterned beam structure 132T₃.

The other end of the second detection beam 132b, the other end of the second detection beam 132d, and the other end of the second detection beam 132f are connected to one another to thereby form a connecting portion 142. A force point 152 is provided at the lower surface of the connecting portion 142. The force point 152 has, for example, a rectangular prismatic shape. The T-patterned beam structures 132T₁, 132T₂, and 132T₃, the connecting portion 142, and the force point 152 constitute the sensing block B₂.

In the sensing block B₂, the first detection beam 132a, the first detection beam 132c, and the second detection beam 132f are parallel to one another. Also, the second detection beams 132b and 132d, and the first detection beam 132e are parallel to one another. The thickness of each detection beam in the sensing block B₂ may be, for example, approximately in the range of 30 μm to 50 μm.

In the sensing block B₃, in plan view, a first detection beam 133a is provided parallel to a side of the support 103 toward the support 102 so as to be at a predetermined distance from the side of the support 103, and the first detection beam 133a extends between the frame 113 toward the support 103 and the coupling portion 123 toward the support 105. A second detection beam 133b is provided such that one end of the second detection beam is coupled at a middle portion of the first detection beam 133a in a longitudinal direction. The second detection beam 133b extends toward the support 102 in a direction perpendicular to the longitudinal direction of the first detection beam 133a. The first detection beam 133a and the second detection beam 133b constitute the T-patterned beam structure 133T₁.

In plan view, a first detection beam 133c is provided parallel to a side of the support 102 toward the support 103 so as to be at a predetermined distance from the side of the support 102, and the first detection beam 133c extends between the frame 113 toward the support 102 and the coupling portion 122 toward the support 105. A second detection beam 133d is provided such that one end of the second detection beam is coupled at a middle portion of the first detection beam 133c in a longitudinal direction. The second detection beam 131d extends toward the support 103 in a direction perpendicular to the longitudinal direction of the first detection beam 133c. The first detection beam 133c and the second detection beam 133d constitute the T-patterned beam structure 133T₂.

In plan view, a first detection beam 133e is provided parallel to a side of the support 105 toward the frame 113 so as to be at a predetermined distance from the side of the support 105, and the first detection beam 133e extends between the coupling portion 123 toward the support 105 and the coupling portion 122 toward the support 105. A second detection beam 133f is provided such that one end of the second detection beam is coupled at a middle portion of the first detection beam 133e in a longitudinal direction, and the second detection beam 133f extends toward the frame 113 so as to be perpendicular to the longitudinal direction of the first detection beam 133e. The first detection beam 133e and the second detection beam 133f constitute the T-patterned beam structure 133T₃.

The other end of the second detection beam 133b, the other end of the second detection beam 133d, and the other end of the second detection beam 133f are connected to one another to thereby form a connecting portion 143. A force point 153 is provided at the lower surface of the connecting portion 143. The force point 153 has, for example, a rectangular prismatic shape. The T-patterned beam structures 133T₁, 133T₂, and 133T₃, the connecting portion 143, and the force point 153 constitute the sensing block B₃.

In the sensing block B₃, the first detection beam 133a, the first detection beam 133c, and the second detection beam 133f are parallel to one another. Also, the second detection beams 133b and 133d, and the first detection beam 133e are parallel to one another. The thickness of each detection beam in the sensing block B₃ may be, for example, approximately in the range of 30 μm to 50 μm.

In the sensing block B₄, in plan view, a first detection beam 134a is provided parallel to a side of the support 104 toward the support 103 so as to be at a predetermined distance from the side of the support 104, and the first detection beam 134a extends between the frame 114 toward the support 104 and the coupling portion 124 toward the support 105. A second detection beam 134b is provided such that one end of the second detection beam is coupled at a middle portion of the first detection beam 134a in a longitudinal direction, and the second detection beam 134b extends toward the support 103 in a direction perpendicular to the longitudinal direction of the first detection beam 134a. The first detection beam 134a and the second detection beam 134b constitute the T-patterned beam structure 134T₁.

In plan view, a first detection beam 134c is provided parallel to a side of the support 103 toward the support 104 so as to be at a predetermined distance from the side of the support 103, and the first detection beam 134c extends between the frame 114 toward the support 103 and the coupling portion 123 toward the support 105. A second detection beam 134d is provided such that one end of the second detection beam is coupled at a middle portion of the first detection beam 134c in a longitudinal direction, and the second detection beam 131d extends toward the support 104 in a direction perpendicular to the longitudinal direction of the first detection beam 134c. The first detection beam 134c and the second detection beam 134d constitute the T-patterned beam structure 134T₂.

In plan view, a first detection beam 134e is provided parallel to a side of the support 105 toward the frame 114 so as to be at a predetermined distance from the side of the support 105, and the first detection beam 134e extends between the coupling portion 124 toward the support 105 and the coupling portion 123 toward the support 105. A second detection beam 134f is provided such that one end of the second detection beam is coupled at a middle portion of the first detection beam 134e in a longitudinal direction, and the second detection beam 131f extends toward the frame 114 so as to be perpendicular to the longitudinal direction of the first detection beam 134e. The first detection beam 134e and the second detection beam 134f constitute the T-patterned beam structure 134T₃. The other end of the second detection beam 134b, the other end of the second detection beam 134d, and the other end of the second detection beam 134f are connected to one another to thereby form a connecting portion 144, and a force point 154 is provided at the lower surface of the connecting portion 144. The force point 154 has, for example, a rectangular prismatic shape. The T-patterned beam structures 134T₁, 134T₂, and 134T₃, the connecting portion 144, and the force point 154 constitute the sensing block B₄.

In the sensing block B₄, the first detection beam 134a, the first detection beam 134c, and the second detection beam 134f are parallel to one another. Also, the second detection beams 134b and 134d, and the first detection beam 134e are parallel to one another. The thickness of each detection beam in the sensing block B₄ may be, for example, approximately in the range of 30 μm to 50 μm.

In this arrangement, the sensor chip 100 includes the four sensing blocks (sensing blocks B₁ to B₄). Each sensing block is disposed in a region surrounded by given supports that are next to each other and are among the supports 101 to 104; a given frame and a given coupling portion each of which couples the given supports that are next to each other; and the support 105. In plan view, for example, any given sensing blocks can be disposed to be point-symmetric with respect to the center of the sensor chip.

Each sensing block includes three T-patterned beam structures. In each sensing block, three T-patterned beam structures include two T-patterned beam structures in which in plan view, a given connecting portion is interposed between first detection beams that are respectively included in two T-patterned beam structures and are disposed parallel to each other. The three T-beam structures also include one T-patterned beam structure including a first detection beam that is disposed parallel to second detection beams included in the respective two T-patterned beam structures. The first detection beam in the one T-patterned beam structure is disposed between the given connecting portion and the support 105.

For example, in the sensing block B₁, three T-patterned beam structures include T-patterned beam structures 131T₁ and 131T₂ in which in plan view, the connecting portion 141 is interposed between the first detection beam 131a and the first detection beam 131c that are disposed parallel to each other. The three T-patterned beam structures also include the T-patterned beam structure 131T₃ including the first detection beam 131e that is disposed parallel to the second detection beams 131b and 131d included in the respective T-patterned beam structures 131T₁ and 131T₂. The first detection beam 131e in the T-patterned beam structure 131T₃ is disposed between the connecting portion 141 and the support 105. The structure in each of the sensing blocks B₂ to B₄ is similar to that in the sensing block B₁.

Each of the force points 151 to 154 is a point to which an external force is applied. Each force point can be formed of, for example, a BOX layer and a support layer in the SOI substrate. The lower surface of each of the force points 151 to 154 substantially corresponds to the lower surface of a corresponding support among the supports 101 to 105.

In this arrangement, when a force or displacement is obtained through each of the four force points 151 to 154, a given beam deforms so as to differ according to a force type, thereby providing a sensor with greater isolation of 6 axes. The number of force points is the same as the number of positions of the strain inducing body to which displacements are input.

One or more internal corners of the sensor chip 100 are preferably R-shaped in order to suppress stress concentration.

The supports 101 to 105 in the sensor chip 100 are connected to a non-movable portion in the strain inducing body 200, and the force points 151 to 154 are connected to a movable portion of the strain inducing body 200. Even if the movable portion and non-movable portion are reversed with respect to each other, the sensor chip 100 functions as a force sensor device. That is, the supports 101 to 105 in the sensor chip 100 are connected to the movable portion of the strain inducing body 200, and the force points 151 to 154 may be connected to the non-movable portion of the strain inducing body 200.

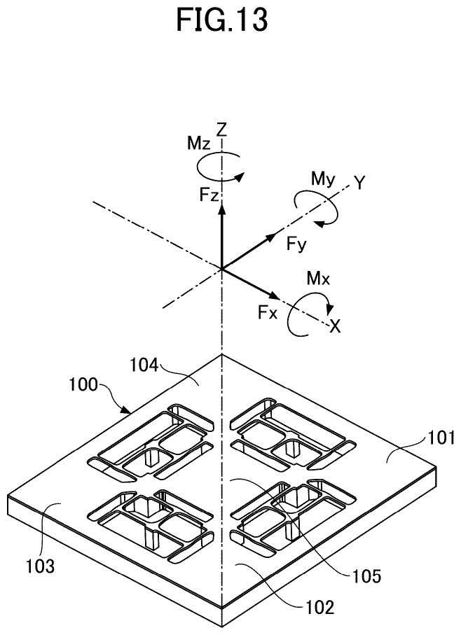

FIG. 13 is a diagram for describing signs for forces and moments applied to axes. As shown in FIG. 13, the force in the X-axis direction is expressed by Fx, the force in the Y-axis direction is expressed by Fy, and the force in the Z-axis direction is expressed by Fz. Also, the moment to cause rotation about the X-axis as an axis is expressed by Mx, the moment to cause rotation about the Y-axis as an axis is expressed by My, and the moment to cause rotation about the Z-axis as an axis is expressed by Mz.

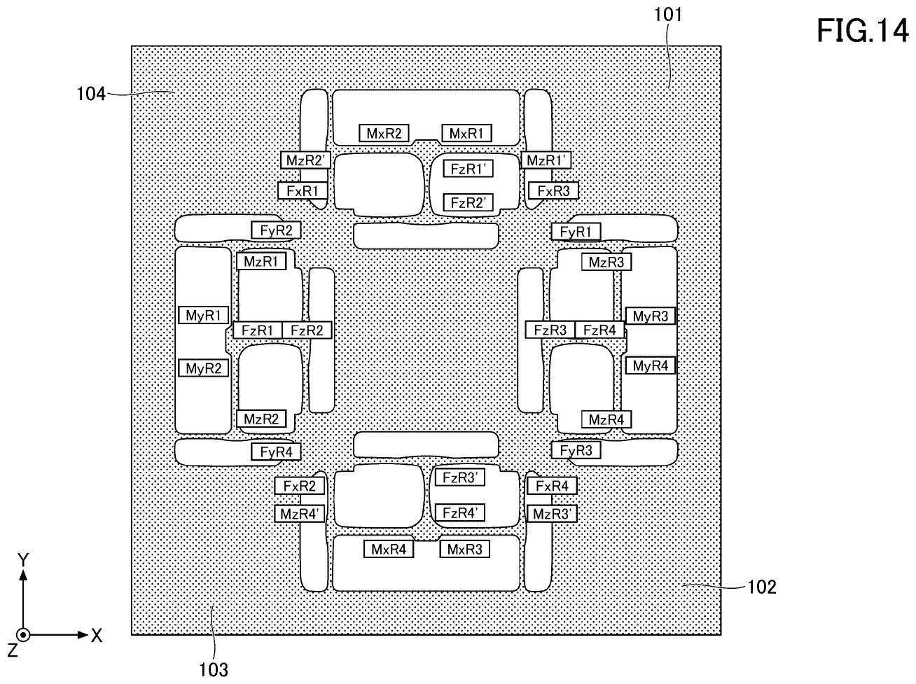

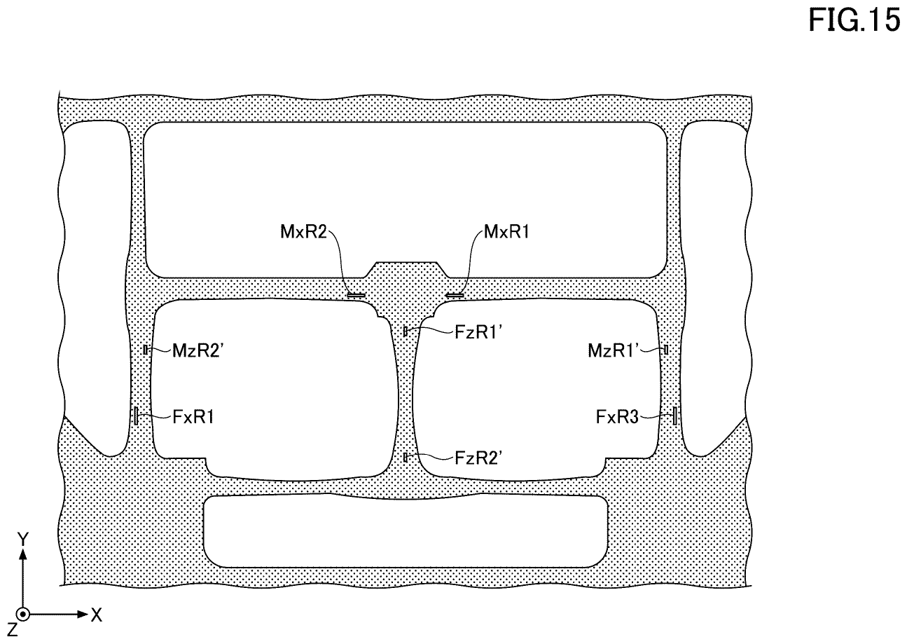

FIG. 14 is a diagram showing the arrangement of piezoresistive elements in the sensor chip 100. FIG. 15 is an enlarged partial view of one sensing block in the sensor chip shown in FIG. 14. As shown in FIG. 14 and FIG. 15, piezoresistive elements are each disposed at a predetermined location of a given sensing block corresponding to a force point among the four force points 151 to 154. The arrangement of the piezoresistive elements in each of the other sensing blocks shown in FIG. 14 is the same as that of the piezoresistive elements in the sensing block shown in FIG. 15.

Referring to FIGS. 9 to 12, FIG. 14, and FIG. 15, in the sensing block B₁ that includes the connecting portion 141 and the force point 151, a piezoresistive element MzR1′ is disposed at a portion of the first detection beam 131a that is toward the second detection beam 131b and is between the second detection beam 131b and the first detection beam 131e. A piezoresistive element FxR3 is disposed at a portion of the first detection beam 131a that is toward the first detection beam 131e and is between the second detection beam 131b and the first detection beam 131e. A piezoresistive element MxR1 is disposed on the second detection beam 131b toward the connecting portion 141.

A piezoresistive element MzR2′ is disposed at a portion of the first detection beam 131c that is toward the second detection beam 131d and is between the second detection beam 131d and the first detection beam 131e. A piezoresistive element FxR1 is disposed at a portion of the first detection beam 131c that is toward the first detection beam 131e and is between the second detection beam 131d and the first detection beam 131e. A piezoresistive element MxR2 is disposed on the second detection beam 131d toward the connecting portion 141.

A piezoresistive element FzR1′ is disposed on the second detection beam 131f toward the connecting portion 141. A piezoresistive element FzR2′ is disposed on the second detection beam 131f toward the first detection beam 131e. The piezoresistive elements MzR1′, FxR3, MxR1, MzR2′, FxR1, and MxR2 are each disposed at a location apart from a middle portion of a corresponding detection beam in a longitudinal direction.

In the sensing block B₂ that includes the connecting portion 142 and the force point 152, a piezoresistive element MzR4 is disposed at a portion of the first detection beam 132a that is toward the second detection beam 132b and is between the second detection beam 132b and the first detection beam 132e. A piezoresistive element FyR3 is disposed at a portion of the first detection beam 132a that is toward the first detection beam 132e and is between the second detection beam 132b and the first detection beam 132e. A piezoresistive element MyR4 is disposed on the second detection beam 132b toward the connecting portion 142.

A piezoresistive element MzR3 is disposed at a portion of the first detection beam 132c that is toward the second detection beam 132d and is between the second detection beam 132d and the first detection beam 132e. A piezoresistive element FyR1 is disposed at a portion of the first detection beam 132c that is toward the first detection beam 132e and is between the second detection beam 132d and the first detection beam 132e. A piezoresistive element MyR3 is disposed on the second detection beam 132d toward the connecting portion 142.

A piezoresistive element FzR4 is disposed on the second detection beam 132f toward the connecting portion 142. A piezoresistive element FzR3 is disposed on the second detection beam 132f toward the first detection beam 132e. The piezoresistive elements MzR4, FxR3, MyR4, MzR3, FyR1, and MyR3 are each disposed at a location apart from a middle portion of a corresponding detection beam in a longitudinal direction.

In the sensing block B₃ that includes the connecting portion 143 and the force point 153, a piezoresistive element MzR4′ is disposed at a portion of the first detection beam 133a that is toward the second detection beam 133b and is between the second detection beam 133b and the first detection beam 133e. A piezoresistive element FxR2 is disposed at a portion of the first detection beam 133a that is toward the first detection beam 133e and is between the second detection beam 133b and the first detection beam 133e. A piezoresistive element MxR4 is disposed on the second detection beam 133b toward the connecting portion 143.

A piezoresistive element MzR3′ is disposed at a portion of the first detection beam 133c that is toward the second detection beam 133d and is between the second detection beam 133d and the first detection beam 133e. A piezoresistive element FxR4 is disposed at a portion of the first detection beam 133c that is toward the first detection beam 133e and is between the second detection beam 133d and the first detection beam 133e. A piezoresistive element MxR3 is disposed on the second detection beam 133d toward the connecting portion 143.

A piezoresistive element FzR4′ is disposed on the second detection beam 133f toward the connecting portion 143. A piezoresistive element FzR3′ is disposed on the second detection beam 133f toward the first detection beam 133e. The piezoresistive elements MzR4′, FxR2, MxR4, MzR3′, FxR4, and MxR3 are each disposed at a location apart from a middle portion of a corresponding detection beam in a longitudinal direction.

In the sensing block B₄ that includes the connecting portion 144 and the force point 154, a piezoresistive element MzR1 is disposed at a portion of the first detection beam 134a that is toward the second detection beam 134b and is between the second detection beam 134b and the first detection beam 134e. A piezoresistive element FyR2 is disposed at a portion of the first detection beam 134a that is toward the first detection beam 134e and is between the second detection beam 134b and the first detection beam 134e. A piezoresistive element MyR1 is disposed on the second detection beam 134b toward the connecting portion 144.

A piezoresistive element MzR2 is disposed at a portion of the first detection beam 134c that is toward the second detection beam 134d and is between the second detection beam 134d and the first detection beam 134e. A piezoresistive element FyR4 is disposed at a portion of the first detection beam 134c that is toward the first detection beam 134e and is between the second detection beam 134d and the first detection beam 134e. A piezoresistive element MyR2 is disposed on the second detection beam 134d toward the connecting portion 144.

A piezoresistive element FzR1 is disposed on the second detection beam 134f toward the connecting portion 144. A piezoresistive element FzR2 is disposed on the second detection beam 134f toward the first detection beam 134e. The piezoresistive elements MzR1, FyR2, MyR1, MzR2, FyR4, and MyR2 are each disposed at a location apart from a middle portion of a corresponding detection beam in a longitudinal direction.

In this arrangement, in the sensor chip 100, each of the sensing blocks individually includes multiple piezoresistive elements. With this arrangement, when inputs are respectively applied to the force points 151 to 154, the sensor chip 100 can detect up to six axes relating to forces in predetermined axis-directions or moments about respective predetermined axes, based on changes in the outputs of multiple piezoresistive elements on given beams.

In addition to the piezoresistive elements used to detect strain, one or more dummy piezoresistive elements may be disposed in the sensor chip 100. The dummy piezoresistive elements are used to adjust variations in stress against detection beams or resistance of a bridge circuit. For example, all piezoresistive elements including piezoresistive elements used to detect strain are arranged so as to be point-symmetrical with respect to the center of the support 105.

In the sensor chip 100, each piezoresistive element among multiple piezoresistive elements to detect the displacement in the X-axis direction and the displacement in the Y-axis direction is disposed on the first detection beam included in a given T-patterned beam structure. Also, each piezoresistive element among multiple piezoresistive elements to detect the displacement in the Z-axis direction is disposed on the second detection beam included in a given T-patterned beam structure. In addition, each piezoresistive element among multiple piezoresistive elements to detect moments about the Z-axis direction is disposed on the first detection beam included in a given T-patterned beam structure. Further, each piezoresistive element among multiple piezoresistive elements to detect moments about the X-axis direction and the Y-axis direction is disposed on the second detection beam included in a given T-patterned beam structure.

Here, each of the piezoresistive elements FxR1 to FxR4 detects the force Fx, each of the piezoresistive elements FyR1 to FyR4 detects the force Fy, and each of the piezoresistive elements FzR1 to FzR4 and FzR1′ to FzR4′ detects the force Fz. Also, each of the piezoresistive elements MxR1 to MxR4 detects the moment Mx, each of the piezoresistive elements MyR1 to MyR4 detects the moment My, and each of the piezoresistive elements MzR1 to MzR4 and MzR1′ to MzR4′ detects the moment Mz.

In this arrangement, in the sensor chip 100, each of the sensing blocks individually includes multiple piezoresistive elements. With this arrangement, when forces or displacements are respectively applied (transmitted) to the force points 151 to 154, the sensor chip 100 can detect up to six axes relating to forces in predetermined directions or moments about the respective directions (axis-directions), based on changes in the outputs of multiple piezoresistive elements on given beams. By changing the thickness and width of each detection beam, equalization of detection sensitivity, increases in detection sensitivity, or the like can be controlled.

By reducing the number of piezoresistive elements, a sensor chip for detecting five axes or less relating to displacements in predetermined axis directions can be provided.

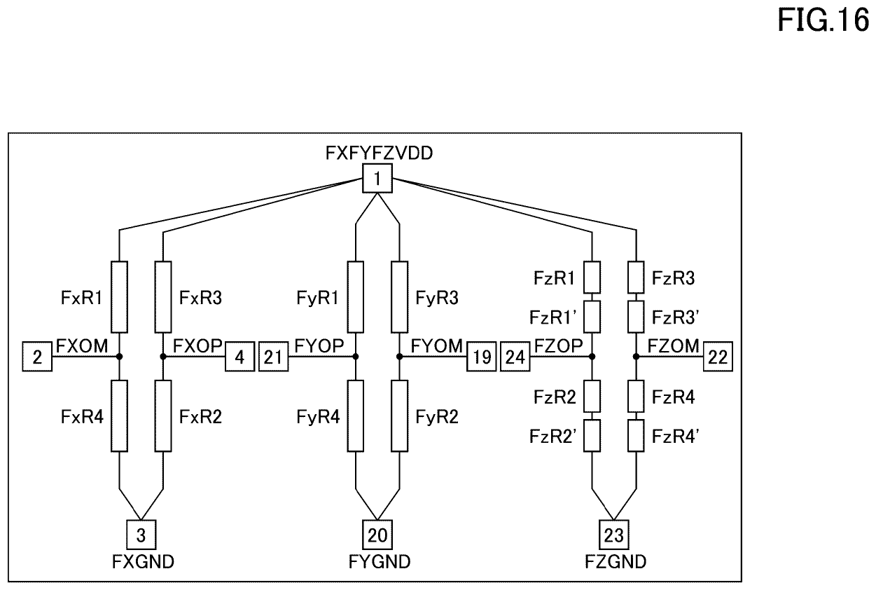

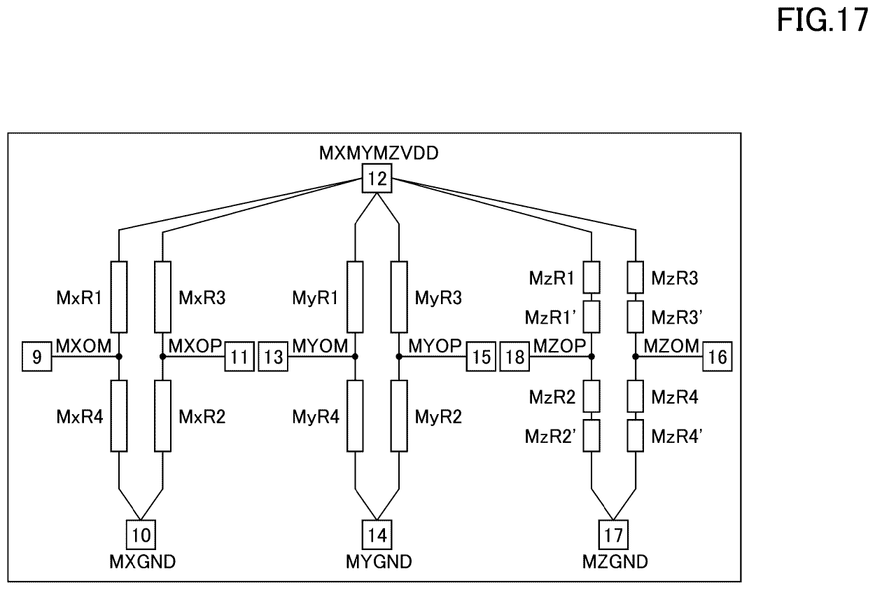

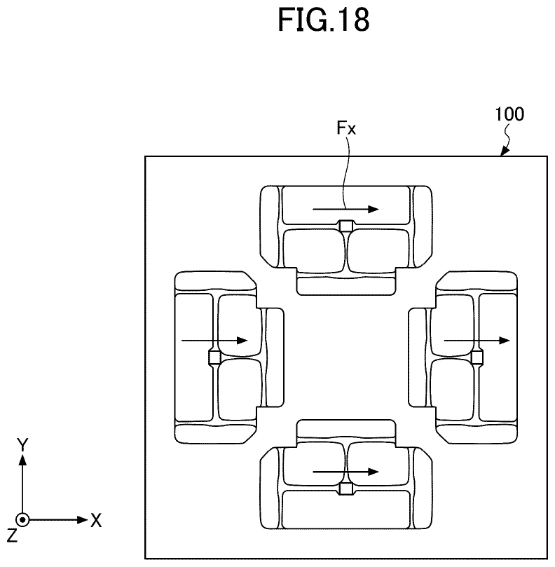

In the sensor chip 100, for example, a detection circuit described below can be used to detect forces and moments. Each of FIG. 16 and FIG. 17 shows an example of the detection circuit that uses piezoresistive elements. In each of FIG. 16 and FIG. 17, numbers surrounded with squares indicate external output terminals. For example, the number “1” indicates a power supply terminal for a Fx-axis, a Fy-axis, and a Fz-axis. The number “2” is a negative output terminal for the Fx-axis. The number “3” indicates a GND terminal for the Fx-axis, and the number “4” indicates a positive output terminal for the Fx-axis. The number “19” indicates a negative output terminal for the Fy-axis, the number “20” indicates a GND terminal for the Fy-axis, and the number “21” indicates a positive output terminal for the Fy-axis. The number “22” indicates a negative output terminal for the Fz-axis, the number “23” indicates a GND terminal for the Fz-axis, and the number “24” indicates a positive output terminal for the Fz-axis.

The number “9” indicates a negative output terminal for the Mx-axis, the number “10” indicates a GND terminal for the Mx-axis, and the number “11” indicates a positive output terminal for the Mx-axis. The number “12” indicates a power supply terminal for the Mx-axis, My-axis, and Mz-axis. The number “13” indicates a negative output terminal for the My-axis, the number “14” indicates a GND terminal for the My-axis, and the number “15” indicates a positive output terminal for the My-axis. The number “16” indicates a negative output terminal for the Mz-axis, the number “17” indicates a GND terminal for the Mz-axis, and the number “18” indicates a positive output terminal for the Mz-axis.

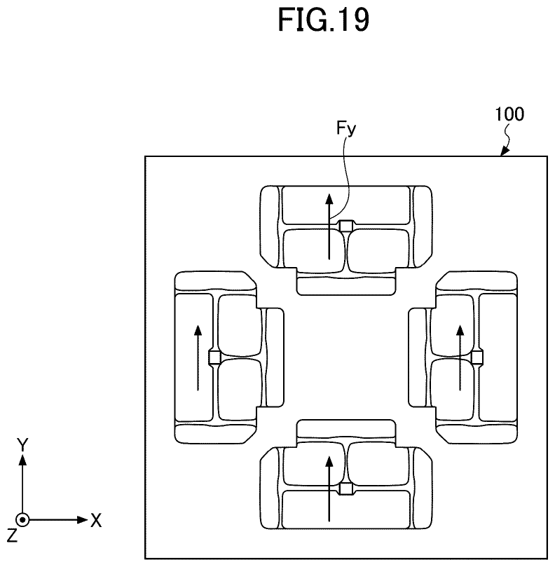

Hereinafter, deformation of the detection beam will be described. FIG. 18 is a diagram describing an input Fx. FIG. 19 is a diagram for describing an input Fy. As shown in FIG. 18, when the input from the strain inducing body 200 on which the sensor chip 100 is mounted is expressed by Fx, all of the four force points 151 to 154 attempt to move in the same direction (rightward direction in an example in FIG. 18). Similarly, as shown in FIG. 19, when the input from the strain inducing body 200 on which the sensor chip 100 is mounted is expressed by Fy, all four force points 151 to 154 attempt to move in the same direction (upward direction in an example in FIG. 19). In this case, although the sensor chip 100 includes four sensing blocks, the respective force points in all sensing blocks move in the same direction, in accordance with displacements in the X-axis direction and Y-axis direction.

In the sensor chip 100, each T-patterned beam structure includes one or more first detection beams that are among all first detection beams in a given T-patterned beam structure and are perpendicular to a displacement direction of the input.

Beams used to detect the inputs Fx include the first detection beams 131a, 131c, 133a, and 133c. Each beam among those beams is a first detection beam in a given T-patterned beam structure, and is at a fixed distance from a given force point. The beams used to detect the inputs Fy include the first detection beams 132a, 132c, 134a, and 134c. Each beam among those beams is a first detection beam in a given T-patterned beam structure, and the first detection beam is at a distance from a given force point.

In response to inputs Fx and the inputs Fy, first detection beams, on which the piezoresistive elements are disposed and that are each included in a given T-patterned beam structure, deform greatly, thereby effectively detecting the input forces. Also, beams not used to detect the inputs are designed to be greatly deformable in accordance with the displacement occurring when the inputs Fx and Fy are applied. With this arrangement, even if the input Fx and/or the input Fy is increased, none of the detection beams are broken.

Conventional sensor chips include beams not being able to deform greatly in accordance with the input Fx and/or the input Fy. In this case, if the input Fx and/or the input Fy is increased, the beams not being deformed might be broken. The sensor chip 100 can address the issue described above. That is, the sensor chip 100 can have increased fracture resistance of beams, even when displacements in various directions occur.

As described above, the sensor chip 100 includes one or more first detection beams perpendicular to the displacement direction of each input, and the one or more first detection beams perpendicular to the displacement direction can greatly deform. With this arrangement, the input Fx and the input Fy can be effectively detected. Also, even when the input Fx and/or the input Fy is increased, none of the detection beams are broken. As a result, the sensor chip 100 can be used for any increased rating capacity, and a measurement range and load bearing can be also improved. For example, the sensor chip 100 may have a rating capacity of 500N, which is about 10 times greater than that of conventional chips.

In each sensing block, beams each extending in three directions in a given T-patterned beam structure are coupled to one another at a given force point, and deform so as to differ according to inputs. Thus, multi-axial forces can be detected more separately.

When beams are arranged in the T pattern, an increased number of paths that are each from a given beam to either a given frame or a given coupling portion is obtained. With this arrangement, a line is easily drawn to the outer periphery of the sensor chip. Therefore, layout flexibility can be improved.

In the sensor chip 100, the first detection beams 131a, 131c, 132a, 132c, 133a, 133c, 134a, and 134c, disposed opposite each other across the respective force points, greatly deform with respect to the moment in the z-axis direction. Therefore, a piezoresistive element can be disposed in a portion or all of these first detection beams.

In addition, with respect to the displacement in the Z-axis direction, the second detection beams 131b, 131d, 131f, 132b, 132d, 132f, 133b, 133d, 133f, 134b, 134d, and 134f, which are each directly connected to a corresponding force point, deform greatly. In this arrangement, one or more piezoresistive elements can be arranged on a portion or all of the second detection beams.

As described above, the substrate 310 and the sensor chip 100 can be wire-bonded in advance by the sensor module 300. In this arrangement, even when the strain inducing body 200 has a large size as compared to the sensor chip 100, a general semiconductor mounting device is used to enable the sensor chip 100 to be attached to the strain inducing body 200. Therefore, the sensor module 300 can improve mass production of the force sensor device 1.

Further, the substrate 310 and the sensor chip 100 can be wire-bonded in advance by the sensor module 300. In this arrangement, difficulty in wire bonding can be reduced and a quality of the wire bonding can be improved compared with a case where the sensor chip 100 is directly attached to the strain inducing body 200.

In addition, the substrate 310 has the opening 314, and thus the force points 151 to 154 of the sensor chip 100 can be exposed. In this arrangement, the force points 151 to 154 can be directly connected to the second connecting portions 235d of the input transmitter 230. In this case, the substrate 310 does not prevent the connection between the sensor chip 100 and the strain inducing body 200. As a result, the force sensor device 1 can provide the same force characteristics as obtained when the sensor chip 100 is directly attached to the strain inducing body 200.

The reinforcing plate 330 has an opening 331 as in the substrate 310, and as a result, the force points 151 to 154 of the sensor chip 100 can be exposed. In this arrangement, the force points 151 to 154 can be directly connected to the second connecting portions 235d of the input transmitter 230. In this case, the reinforcing plate 330 does not prevent the connection between the sensor chip 100 and the strain inducing body 200. As a result, the force sensor device 1 can provide the same force characteristics as obtained when the sensor chip 100 is directly attached to the strain inducing body 200.

In addition, inspection can be performed on the form of the sensor module 300, and the inspection can be performed simply. Even when it is determined that there is a fault in the inspection, an object can be eliminated as the sensor module 300 in a step before attaching the object to a relatively expensive strain inducing body 200. Thus, disposal costs can be reduced ultimately.

### Sensor Module 300 in Modification

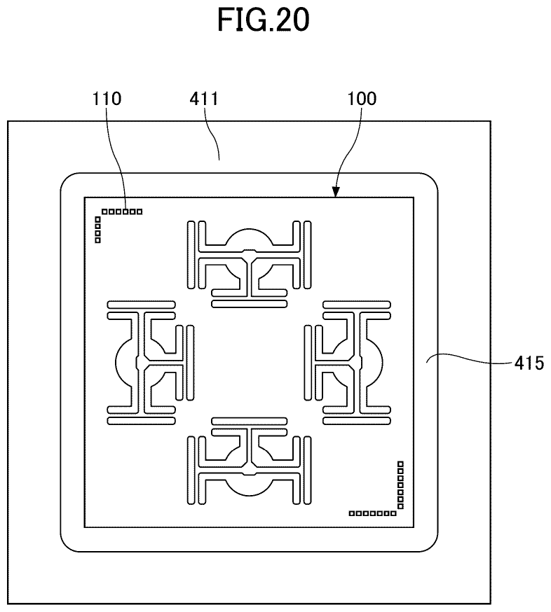

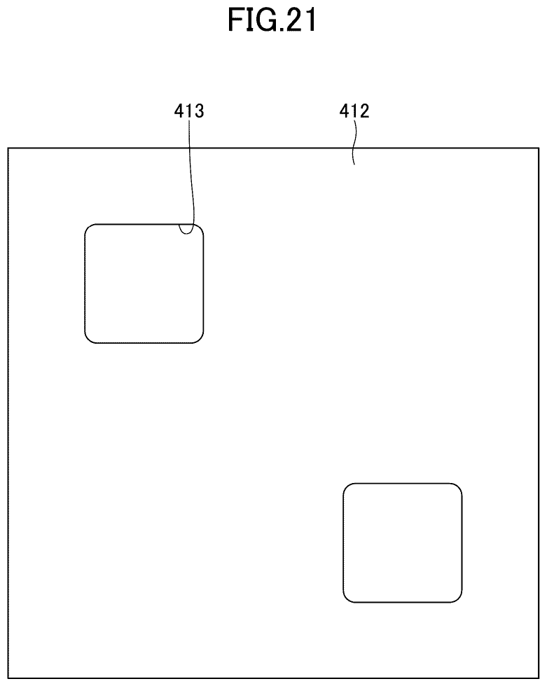

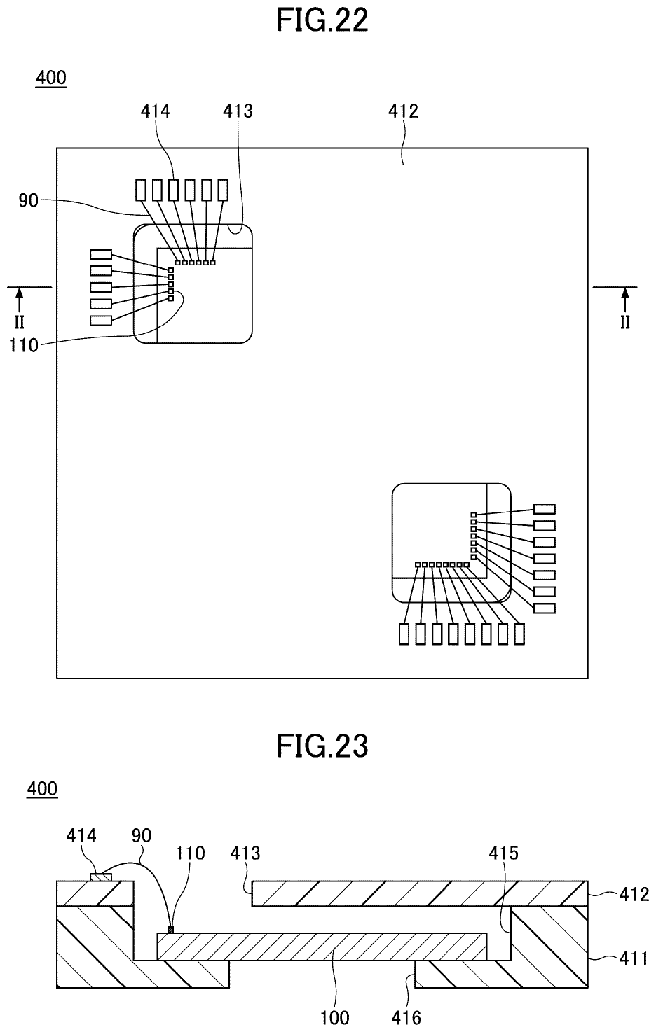

FIG. 20 is a plan view of a state of a sensor module 400 from which an upper substrate 412 is removed in a modification of the embodiment. FIG. 21 is a plan view of the upper substrate 412 of the sensor module 400 in the modification of the embodiment. FIG. 22 is a plan view of the sensor module 400 in the modification of the embodiment. FIG. 23 is a view viewed in a II-II section of FIG. 22.

The sensor module 400 shown in FIGS. 20 to 23 differs from the sensor module 300 shown in FIGS. 5 to 8 in that the sensor module 400 does not have a protective frame and has a different substrate structure. The sensor module 400 includes a mounted substrate 411 having a cavity 415 as shown in FIG. 20; the sensor chip 100 that is mounted in the cavity 415 of the mounted substrate 411 and that detects a predetermined axial displacement; and the upper substrate 412 that covers the mounted substrate 411 and the sensor chip 100. The sensor chip 100 is mounted such that the lower surface of the sensor chip 100, which is situated opposite the electrode formation surface on which the second electrodes 110 are formed, is oriented toward the lower surface of the cavity 415. As shown in FIG. 23, the mounted substrate 411 preferably includes an opening 416 through which the force points 151 to 154 of the sensor chip 100 are exposed.

As shown in FIG. 21, the upper substrate 412 includes an opening 413 through which the second electrode 110 of the sensor chip 100 is exposed. As shown in FIG. 22, first electrodes (bonding pads) 414 are formed on the upper surface (one surface) of the upper substrate 412, and the first electrodes 414 and the second electrodes 110 of the sensor chip 100 are electrically connected by bonding wires 90. The first electrodes 414 are preferably provided on the periphery of the opening 413 in order to reduce distances between the first electrodes 414 and the second electrodes 110 when bonding wires. For example, a wiring member such as a flexible flat cable (FFC) may be connected to the upper surface of the upper substrate 412.

The thickness of each of the mounted substrate 411 and the upper substrate 412, and the materials that constitute the mounted substrate 411 and the upper substrate 412 may can be adopted as in the substrate 310 of the sensor module 300.

Although the preferred embodiments are described above in detail, the above-described embodiments are not limiting. Various modifications and substitutions the above-described embodiments can be made without departing from the scope described in the claims.

For example, the above-described embodiments are described using an example in which a strain inducing body is fastened to a measured object with screws, but the example is not limiting. Various fasteners such as bolts or rivets can be used as long as the strain inducing body can be fixed to the measured object.

This international application claims priority to Japanese Patent Application No. 2022-009568, filed on Jan. 25, 2022, and the entire contents of which are incorporated herein.

### DESCRIPTION OF SIGNS

1 force sensor device, 90 bonding wire, 100 sensor chip, 101 to 105 support, 110 second electrode, 111 to 114 frame, 121 to 124 connecting portion, 131a, 131c, 131e, 131g, 132a, 132c, 132e, 133a, 133c, 133e, 134a, 134c, 134e first detection beam, 131b, 131d, 131f, 131h, 132b, 132d, 132f, 133b, 133d, 133f, 134b, 134d, 134f second detection beam, 131T₁, 131T₂, 131T₃, 131T₄, 132T₁, 132T₂, 132T₃, 133T₁, 133T₂, 133T₃, 134T₁, 134T₂, 134T₃ T-shaped beam structure, 141 to 144 connecting portion, 151 to 154 force point, 200 strain inducing body, 210 force receiving plate, 238 screw hole, 220 strain inducing portion, 224 first connecting portion, 230 input transmitter, 232 central portion, 234 first coupling portion, 235 accommodating portion, 235a vertical support, 235b horizontal support, 235c second coupling portion, 235d second connecting portion, 238 screw hole, 240 cover plate, 300, 400 sensor module, 310 substrate, 311 mounting portion, 312 arm portion, 313, 414 first electrode, 314 first opening, 320 protective frame, 315, 321, 332 locating hole, 330 reinforcing plate, 331 second opening, 411 mounted substrate, 412 upper substrate, 413, 416 opening, 415 cavity

1. A sensor module comprising:
a substrate;
a sensor chip mounted on one surface of the substrate and configured to detect a predetermined axial displacement;
a bonding wire electrically coupling a first electrode formed on the one surface of the substrate to a second electrode of the sensor chip; and
a protective frame provided at the periphery of the one surface of the substrate, the protective frame being apart from the bonding wire.

2. The sensor module according to claim 1, wherein an upper surface of the protective frame is situated at a position higher than a top position of the bonding wire.

3. The sensor module according to claim 2, wherein the sensor chip includes
an electrode-formation surface on which the second electrode is formed, and
a lower surface located opposite the electrode-formation surface,
wherein the sensor chip is mounted such that the lower surface is oriented toward the one surface of the substrate, and
wherein the substrate has a first opening through which a portion of the lower surface of the sensor chip is exposed.

4. The sensor module according to claim 3, wherein the sensor chip includes a force point to which an external force is to be applied, and
wherein the force point is exposed from the first opening.

5. The sensor module according to claim 4, further comprising:
a reinforcing plate provided on another surface of the substrate,
wherein the reinforcing plate has a second opening through which the force point is exposed.

6. The sensor module according to claim 5, wherein the substrate includes
a mounting portion on which the sensor chip is mounted, and
an arm portion from which the mounting portion extends.

7. A force sensor device comprising:
a strain inducing body including a strain inducing portion, the strain inducing portion including
a movable portion configured to deform in accordance with a predetermined axial force or a moment about a predetermined axis, and
a non-movable portion configured to fail to deform in accordance with the force or the moment;
an input transmitter coupled to the non-movable portion and configured to fail to deform in accordance with the force or the moment; and
the sensor module of claim 1 fixed to the input transmitter.

8. The force sensor device according to claim 7, wherein the input transmitter includes a connecting portion, and
wherein the connecting portion is coupled to a force point of the sensor chip.

9. The force sensor device according to claim 8, wherein the input transmitter includes an accommodating portion that accommodates the sensor module.
